(19) United States
(12) Patent Application Publication
(10) Pub. No.: US 2005/0259071 A1
(43) Pub. Date: Nov. 24, 2005

(54) Secure enclosure for portable electronic display device operated by push buttons

(76) Inventor: Douglas L. Pearlson, Miami, FL (US)

Correspondence Address: DOUGLAS L. PEARLSON, P.O. BOX 560100, MIAMI, FL, 33256-0100, US

(21) Appl. No.: 11/131,500

(22) Filed: May 18, 2005

Related U.S. Application Data
(60) Provisional application No. 60/573,012, filed on May 19, 2004.

(51) Int. Cl. G09G 5/00

(52) U.S. Cl. 345/156

(57) ABSTRACT

A secure robust protective enclosure for a portable electronic display device that incorporates a sufficiently ridged transparent window so as to limit the user interface to push buttons located on the front of the enclosure. The enclosure's control buttons mechanically actuate corresponding control buttons on the enclosed portable electronic display device. When only two control buttons are used, the user interface is simplified to reduce the training required to use the device. The user interface button or buttons are labeled via shape, color and a numeral, to assist in language-neutral identification of the control button's function. Typically one button functions as a “tab key” that cycles through the available choices that are shown on the portable electronic display device's display screen and the other button functions as a “enter key” that activates the selected choice.

### U.S. PATENT DOCUMENTS

| | | | |
|---|---|---|---|
| 6456487 | September 2002 | Hetterick | 361/683 |
| 6519141 B2 | February 2003 | Tseng et al. | 361/683 |
| 6646864 B2 | November 2003 | Richardson | 361/683 |
| 6646866 | November 2003 | Kao | 361/683 |
| 6819552 | November 2004 | Lam, et al. | 361/683 |

### CROSS-REFERENCE TO RELATED APPLICATIONS

The present application claims priority to and benefit of U.S. Provisional Application Ser. No. 60/573,012 filed May 19, 2004 by Douglas L. Pearlson entitled “Secure protective enclosure for electronic display device operated by push buttons”, the entire contents of which are hereby specifically incorporated by reference for all it discloses and teaches.

### STATEMENT REGARDING FEDERALLY SPONSORED RESEARCH OR DEVELOPMENT

Not Applicable

### BACKGROUND OF THE INVENTION

A. Field of the Invention

The present invention pertains generally to protective enclosures and specifically to protective enclosures for portable hand held electronic devices that have a display screen.

B. Description of the Background

Portable hand held electronic devices such as Personal Digital Assistants, or PDAs are used extensively in a wide range of applications. Most devices are controlled by a combination of push buttons on the face of the unit and a touchscreen display activated by a stylus or finger. These devices are vulnerable to damage by dropping or abuse. Before they can effectively be made available for use by the public in a museum, nature park, stadium or similar setting they must be secured in a robust protective enclosure. The cases and enclosures presently available are designed to protect the hand held device and facilitate easy access to the device's controls including the touch screen, if one is available. This level of access and control complexity is not desirable for applications where the device is made available to the public as a temporary interpretive or adaptive resource. For such applications that need to “lock down” the device's controls or must function in a harsh environment, a more secure restrictive enclosure and simple user interface is desirable.

### BRIEF SUMMARY OF THE INVENTION

The present invention overcomes the disadvantages and limitations of the prior art by providing a protective case that limits the public user's access to only the control buttons necessary to operate the program running on the electronic device. The user interface button or buttons incorporated into the front of the present invention are labeled via shape, color and a numeral, to assist in language-neutral identification of the control button's function. A large integrated handle can be incorporated to facilitate carrying and prevent accidently dropping the enclosure. When the two button interface is used, the user interface is simplified, thus reducing the training required to use the device. The enclosure can only be opened with a special tool when maintenance is required or to load software updates.

The present invention may be configured to allow infrared, wireless radio and other types of communications between a device inside the case and an external electronic system while the device remains in the protective case. The present invention also may allow for optional direct electrical connections to be made through the case without having to open the case. For example, to charge the device's battery or connect a headset speaker. Further, additional connections through the enclosure for light, acoustics, heat, mechanical actuation, etc. may be provided.

### BRIEF DESCRIPTION OF THE SEVERAL VIEWS OF THE DRAWING

FIG. 1 is a front view of an embodiment of the invention, showing a section line.

FIG. 2 is a bottom view of an embodiment of the invention.

FIG. 3 is a side view of an embodiment of the invention.

FIG. 4 is a section view of an embodiment of the invention defined in FIG. 1 section marked A-A.

### DETAILED DESCRIPTION OF THE INVENTION

In describing the present invention illustrated in the drawings, specific terminology is used for the sake of clarity. However the invention is not intended to be limited to the specific terms so selected, and each specific term includes all technically equivalent terms for components operating in a similar manner to accomplish a similar purpose.

Embodiment 100 is designed to hold a conventional portable electronic display device such as a Palm Pilot PDA, Pocket PC or similar product. These devices typically use a touch screen for display and data entry. The touch screen display comprises either a color or black and white liquid crystal display with a touch sensitive device mounted on top of the display and one or more control buttons mounted on the face of the portable electronic display device. The display screen is used for displaying graphics, text, and other rich media elements to the user. The present invention will prevent access to the touchscreen while the portable electronic display device is secured inside the enclosure.

The portable electronic display device may be secured in the enclosure using various mounting techniques. For example, the portable electronic display device may be mounted using foam inserts in the enclosure. In another embodiment, the portable electronic display device may be mounted by attaching the portable electronic display device to the enclosure with a fastener. In another embodiment, the portable electronic display device may be held in place by incorporating a molded cavity in the enclosure. Those skilled in the art may use other types of locating and holding mechanisms without deviating from the spirit of the present invention

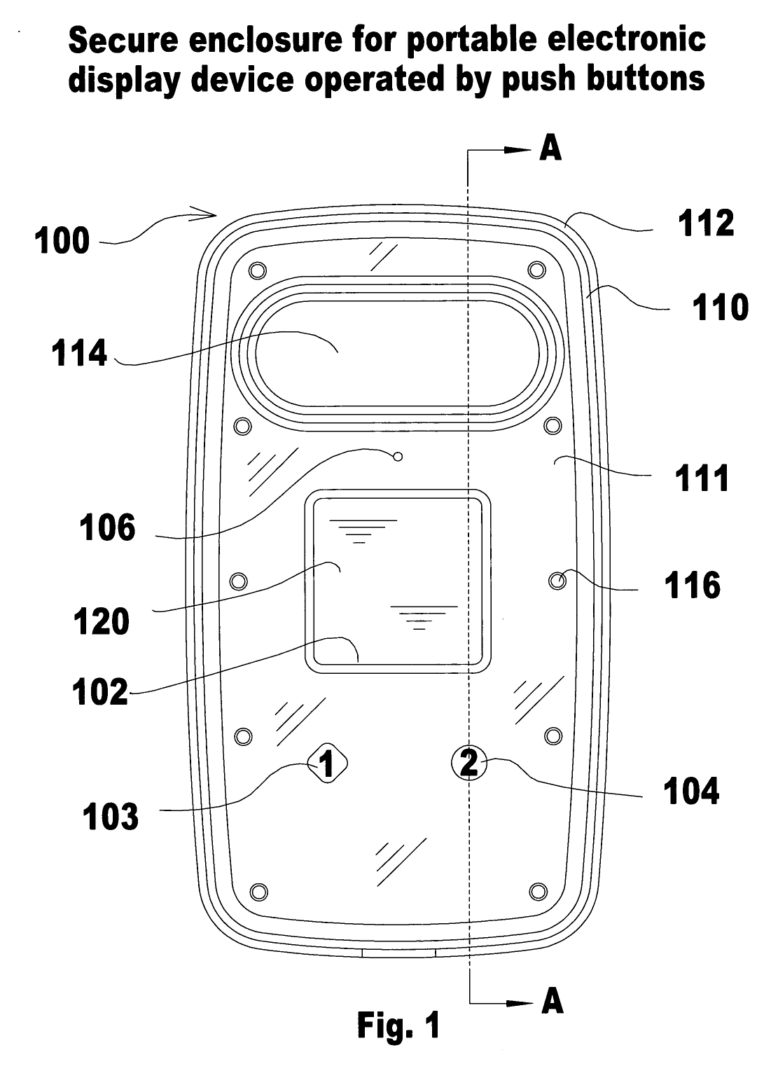

FIG. 1 is a plan view of an embodiment of the invention. Embodiment 100 comprises a rigid ABS plastic enclosure fabricated in three sections: the rear or bottom section 112, the center section 110 and the front or top section 111. An opening 102 in the top section 111 and center section 110 is positioned to line up with the display screen of the portable electronic display device to be secured in the enclosure. Opening 102 is approximately the same size as the display screen in the portable electronic display device. A transparent plastic window 120 is assembled in the top 111 and center 110 section to prevent the user from activating the portable electronic display device's touch screen. The application program running on the portable electronic display device is controlled by using the two control buttons 103 and 104 incorporated into the top or front 111 of the enclosure. The control buttons 103 and 104 are labeled via shape, color and a numeral, to assist in language-neutral identification of the control button's function. The control buttons are located so as to line-up with the corresponding control buttons on the face of the portable electronic display device mounted in the enclosure. The control buttons are assembled in top section 111 and center section 110 with a spring washer, FIG. 4-121. The spring returns the button to a neutral position after finger pressure is removed from the button. Typically one button functions as a “tab key” that cycles through the available choices that are shown on the portable electronic display device's display screen and the other button functions as a “enter key” that activates the selected choice.

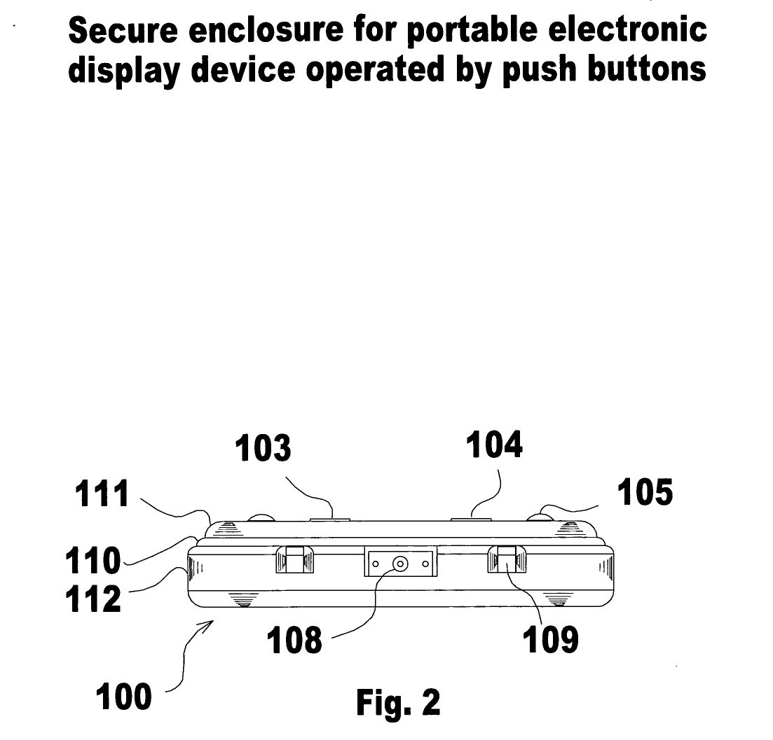

FIG. 2 is a bottom view of embodiment 100 of the invention. An electrical connection 108 is recessed in the bottom section 112 to provide a method to recharge and/or power the portable electronic display device without opening the enclosure. Two slots 109 are formed in the bottom section to assist in aligning the power connector to an external power plug. The three sections of the enclosure shown in embodiment 100 are fastened together with threaded fasteners 105.

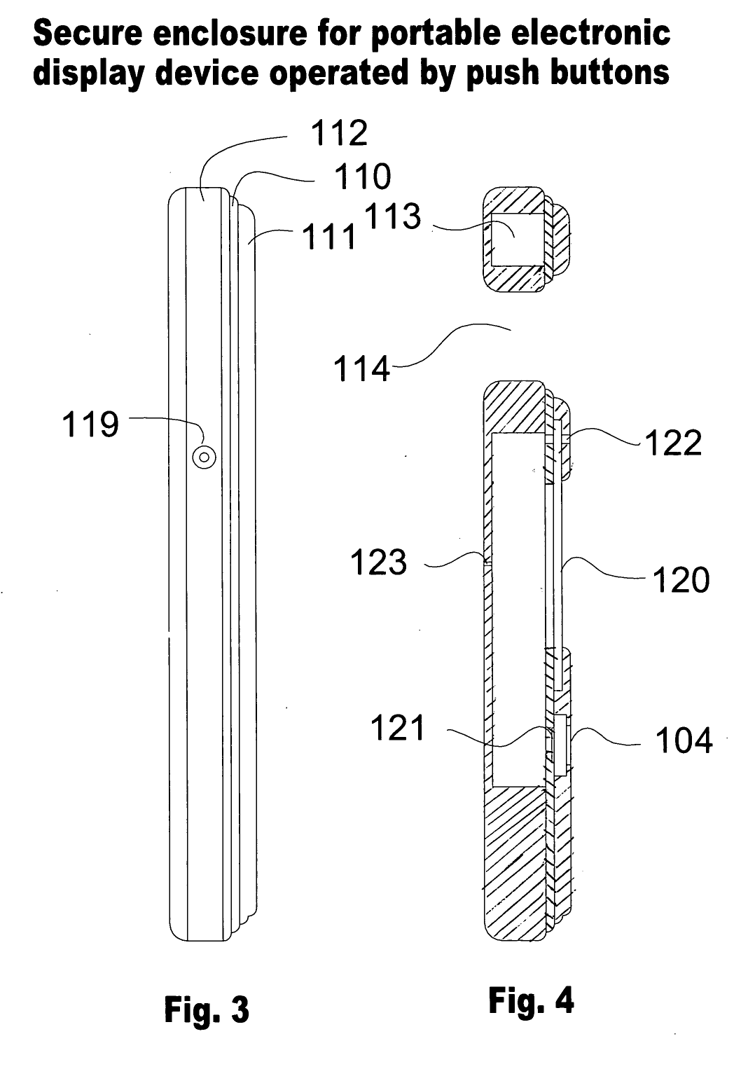

FIG. 3 is a side view of embodiment 100 of the invention. If an external audio headset is required a standard jack 119 is recessed into the side of the back or bottom section 112.

FIG. 4 is a section view of an embodiment of the invention defined in FIG. 1 section marked A-A. Inside the handle 114 there is a space for an auxiliary battery that extends the time the portable electronic display device can be used before recharging.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. An enclosure for a portable electronic display device with a transparent window that is sufficiently rigid to restrict persons using the device to only control the device secured inside said enclosure by pressing one or more control buttons located in the face of the enclosure, or by external radio or infrared signals.

2. The enclosure according to claim 1 that also incorporates an electrical connection in the enclosure to allow the portable electronic display device to be powered and recharged without opening the enclosure.

3. The enclosure according to claim 1 that also incorporates an electrical connection in the enclosure to allow an external audio headphone or speaker to be connected to the portable electronic display device without opening the enclosure.

4. The enclosure according to claim 1 that also incorporates a credit card swipe reader in the enclosure.

5. The enclosure according to claim 1 that also incorporates a bar code reader in the enclosure.

6. The enclosure according to claim 1 that also incorporates a RFID reader in the enclosure.

7. The enclosure according to claim 1 that also incorporates a GPS receiver in the enclosure.
